(19) United States
(12) Patent Application Publication
(10) Pub. No.: US 2023/0044920 A1
(43) Pub. Date: Feb. 9, 2023

(54) ROUTING APPARATUS, ROUTING METHOD, AND NON-TRANSITORY COMPUTER-READABLE STORAGE MEDIUM STORING ROUTING PROGRAM

(71) Applicant: Woven Planet Holdings, Inc., Tokyo (JP)

(72) Inventors: Toshinobu WATANABE, Tokyo-to (JP); Yoshitaka ADACHI, Tokyo-to (JP)

(21) Appl. No.: 17/812,273

(22) Filed: Jul. 13, 2022

(30) Foreign Application Priority Data
Aug. 6, 2021 (JP) 2021-130234

(51) Int. Cl. B60W 60/00

(52) U.S. Cl. CPC B60W 60/0015; B60W 2556/45

(57) ABSTRACT

The routing apparatus predicts occurrence of remote assistance for each vehicle based on a currently selected route of each vehicle and an operation status of each vehicle and predicts an operating rate of operators as a whole based on a prediction result of the occurrence of remote assistance for each vehicle. When the operating rate is higher than the target range, the routing apparatus changes the combination of routes of all vehicles being remotely monitored to a combination that reduces an assistance cost of the operators as a whole as compared with a currently selected combination. When the operating rate is lower than the target range, the routing apparatus changes the combination of routes of all vehicles being remotely monitored to a combination that reduces a vehicle cost of vehicles as a whole as compared with the currently selected combination.

### CROSS-REFERENCE TO RELATED APPLICATION

The present application claims priority under 35 U.S.C. § 119 to Japanese Patent Application No. 2021-130234, filed Aug. 6, 2021, the contents of which application are incorporated herein by reference in their entirety.

### BACKGROUND

### Field

The present disclosure relates to a routing apparatus, a routing method, and a routing program for selecting a route on which a vehicle capable of autonomous traveling and subject to remote assistance by an operator travels from among a plurality of route candidates for each vehicle.

### Background Art

An autonomous vehicle basically travels autonomously. However, there are cases where autonomous judgement by the autonomous vehicle is uncertain or more sure safety judgement is required. Therefore, it has been considered not to leave everything to the autonomous judgement by the autonomous vehicle but to assist the autonomous traveling of the autonomous vehicle by monitoring the autonomous vehicle remotely and, if necessary, transmitting determination and remote traveling instruction to the vehicle from an operator. One of the prior art related to remote monitoring of the autonomous vehicle is disclosed in JP2019-190835A.

The prior art disclosed in JP2019-190835A calculates an operation cost for each section for each route candidate and selects a route candidate minimizing the total operation cost of all sections. The operation cost of each section is calculated by multiplying the traveling time of each section by a weighting factor. The weighting factor for the operation cost is determined according to the operating mode. For example, the weighting factor for the operation cost of the remote operation mode is larger than the weighting factor for the operation cost of the autonomous traveling mode. In addition, in the prior art, it is said that the weighting factor for the operation cost of the remote operation mode may be set to a larger value as the operator operating rate is higher.

The above-described prior art selects the optimum route for each autonomous vehicle. However, when each autonomous vehicle independently selects the optimum route, vehicles are concentrated on one route, resulting in an increase in the load of operators and congestion of the route.

As prior art documents representing the technical level of the technical field to which the present disclosure belongs, in addition to JP2019-190835A, JP2019-185279A and JP2019-160146A can be exemplified.

### SUMMARY

The present disclosure has been made in view of the problems as described above. An object of the present disclosure is to provide a technique that contributes to the reduction of personnel expenses of operators while maintaining the smooth operation of a plurality of vehicles capable of autonomous traveling and subject to remote assistance by the operators.

The present disclosure provides a routing apparatus for achieving the above object. The routing apparatus of the present disclosure is an apparatus for selecting a route of a vehicle from a plurality of route candidates for each vehicle, being applied to a remote monitoring system configured to cause a plurality of operators to remotely monitor a plurality of vehicles capable of autonomous traveling. The remote monitoring system is a system to cause any one of the plurality of operators to perform remote assistance in response to an assistance request from any one of the plurality of vehicles.

The routing apparatus of the present disclosure comprises at least one memory storing at least one program and at least one processor coupled to the at least one memory. The at least one program is configured to cause the at least one processor to execute processing comprising the following processes.

A first process is to predict occurrence of remote assistance for each of the plurality of vehicles based on a currently selected route of each of the plurality of vehicles and an operation status of each of the plurality of vehicles.

A second process is to predict an operator operating rate of the plurality of operators as a whole based on a prediction result of the occurrence of remote assistance for each of the plurality of vehicles.

A third process is a process executed in response to the predicted operator operating rate being higher than a target range. The third process is to change a combination of routes of the plurality of vehicles to a combination to reduce an assistance cost of the plurality of operators as a whole as compared with a currently selected combination.

A fourth process is a process executed in response to the predicted operator operating rate being lower than the target range. The fourth process is to change the combination of routes of the plurality of vehicles to a combination to reduce a vehicle cost of the plurality of vehicles as a whole as compared with the currently selected combination.

According to the routing apparatus of the present disclosure, when the predicted operator operating rate is higher than the target range, the operator operating rate can be automatically lowered to the target range by selecting routes to reduce the assistance cost. On the other hand, when the predicted operator operating rate is lower than the target range, since operators can afford to perform remote assistance sufficiently, it is possible to operate the plurality of vehicles smoothly by selecting routes to reduce the vehicle cost. That is, according to the routing apparatus of the present disclosure, by selecting routes in consideration of the vehicle cost and the assistance cost so as to keep the operator operating rate within the target range, it is possible to achieve the reduction of personnel expenses of operators while maintaining the smooth operation of the plurality of vehicles.

The third process may include extracting a predetermined number of combinations of routes of the plurality of vehicles in the order of high reduction effect of the assistance cost and selecting the combination to reduce the assistance cost among the predetermined number of combinations. Selecting the combination after changing among the predetermined number of combinations extracted in order of high reduction effect of the assistance cost makes it possible to ensure the reduction of the assistance cost by changing the combination of routes of the plurality of vehicles.

Furthermore, the third process may include selecting a combination having higher reduction effect of the assistance cost as the operator operating rate is higher than the target range. Making such a selection makes it possible to increase the certainty that the operator operating rate is lowered to the target range.

The fourth process may include extracting a predetermined number of combinations of routes of the plurality of vehicles in order of high reduction effect of the vehicle cost and selecting the combination to reduce the vehicle cost among the predetermined number of combinations. Selecting the combination after changing among the predetermined number of combinations extracted in order of high reduction effect of the vehicle cost makes it possible to ensure the reduction of the vehicle cost by changing the combination of routes of the plurality of vehicles.

Furthermore, the fourth process may include selecting a combination having higher reduction effect of the vehicle cost as the operator operating rate is lower than the target range. Making such a selection makes it possible to operate the plurality of vehicles smoothly by more effectively utilizing the margin of performing remote assistance.

Also, the present disclosure provides a routing method for achieving the above object. The routing method of the present disclosure is a method applied to a remote monitoring system configured to cause a plurality of operators to remotely monitor a plurality of vehicles capable of autonomous traveling and cause any one of the plurality of operators to perform remote assistance in response to an assistance request from any one of the plurality of vehicles. This routing method is a method of selecting a route of a vehicle from a plurality of route candidates for each vehicle. The routing method includes the following steps.

A first step is to predict occurrence of remote assistance for each of the plurality of vehicles based on a currently selected route of each of the plurality of vehicles and an operation status of each of the plurality of vehicles.

A second step is to predict an operator operating rate of the plurality of operators as a whole based on a prediction result of the occurrence of remote assistance for each of the plurality of vehicles

A third step is a step to be performed when the predicted operator operating rate is higher than a target range. The third step is to change a combination of routes of the plurality of vehicles to a combination to reduce an assistance cost of the plurality of operators as a whole as compared with a currently selected combination.

A fourth step is a step to be performed when the predicted operator operating rate is lower than the target range. The fourth step is to change the combination of routes of the plurality of vehicles to a combination to reduce a vehicle cost of the plurality of vehicles as a whole as compared with the currently selected combination.

Further, the present disclosure provides a routing program for achieving the above object. The routing program of the present disclosure may be stored on a non-transitory computer-readable storage medium. The routing program of the present disclosure is a program for selecting a route of a vehicle from a plurality of route candidates for each vehicle, being applied to a remote monitoring system configured to cause a plurality of operators to remotely monitor a plurality of vehicles capable of autonomous traveling. The remote monitoring system is a system to cause any one of the plurality of operators to perform remote assistance in response to an assistance request from any one of the plurality of vehicles. The routing program of the present disclosure is configured to cause the computer to execute processing comprising the following processes.

A first process is to predict occurrence of remote assistance for each of the plurality of vehicles based on a currently selected route of each of the plurality of vehicles and an operation status of each of the plurality of vehicles.

A second process is to predict an operator operating rate of the plurality of operators as a whole based on a prediction result of the occurrence of remote assistance for each of the plurality of vehicles.

A third process is a process executed in response to the predicted operator operating rate being higher than a target range. The third process is to change a combination of routes of the plurality of vehicles to a combination to reduce an assistance cost of the plurality of operators as a whole as compared with a currently selected combination.

A fourth process is a process executed in response to the predicted operator operating rate being lower than the target range. The fourth process is to change the combination of routes of the plurality of vehicles to a combination to reduce a vehicle cost of the plurality of vehicles as a whole as compared with the currently selected combination.

According to the routing method and the routing program of the present disclosure, when the predicted operator operating rate is higher than the target range, the operator operating rate can be automatically lowered to the target range by selecting routes to reduce the assistance cost. On the other hand, when the predicted operator operating rate is lower than the target range, since operators can afford to perform remote assistance sufficiently, it is possible to operate the plurality of vehicles smoothly by selecting routes to reduce the vehicle cost. That is, according to the routing method and the routing program of the present disclosure, by selecting routes in consideration of the vehicle cost and the assistance cost so as to keep the operator operating rate within the target range, it is possible to achieve the reduction of personnel expenses of operators while maintaining the smooth operation of the plurality of vehicles.

As described above, according to the routing apparatus, the routing method, and the routing program of the present disclosure, it is possible to contribute to the reduction of personnel expenses of operators while maintaining the smooth operation of a plurality of vehicles capable of autonomous traveling and subject to remote assistance by the operators.

### BRIEF DESCRIPTION OF THE DRAWINGS

FIG. 1 is an overall view of a remote monitoring system to which a routing apparatus according to an embodiment of the present disclosure is applied.

FIG. 2 is a diagram for explaining routes of autonomous vehicles.

FIG. 3 is a block diagram showing an example of a configuration of the routing apparatus according to the embodiment of the present disclosure.

FIG. 4 is a diagram illustrating extraction of route candidates when the predicted value of the operator operating rate is higher than the target range.

FIG. 5 is a diagram illustrating extraction of route candidates when the predicted value of the operator operating rate is lower than the target range.

FIG. 6 is a diagram showing selection of a combination of routes according to the predicted value of the operator operating rate.

FIG. 7 is a flowchart illustrating a procedure for selecting a combination of routes by the routing apparatus according to the embodiment of the present disclosure.

### DETAILED DESCRIPTION

Hereunder, an embodiment of the present disclosure will be described with reference to the drawings. However, in the embodiment described below, when a numerical value such as the number, quantity, amount, or range of each element is mentioned, the technical idea according to the present disclosure is not limited to the mentioned numerical value except for a case where it is clearly specified in particular or a case where it is clearly specified to the numerical value in principle. In addition, a structure or the like described in the embodiment described below is not necessarily essential to the technical idea according to the present disclosure except for a case where it is clearly specified in particular or a case where it is clearly specified in principle.

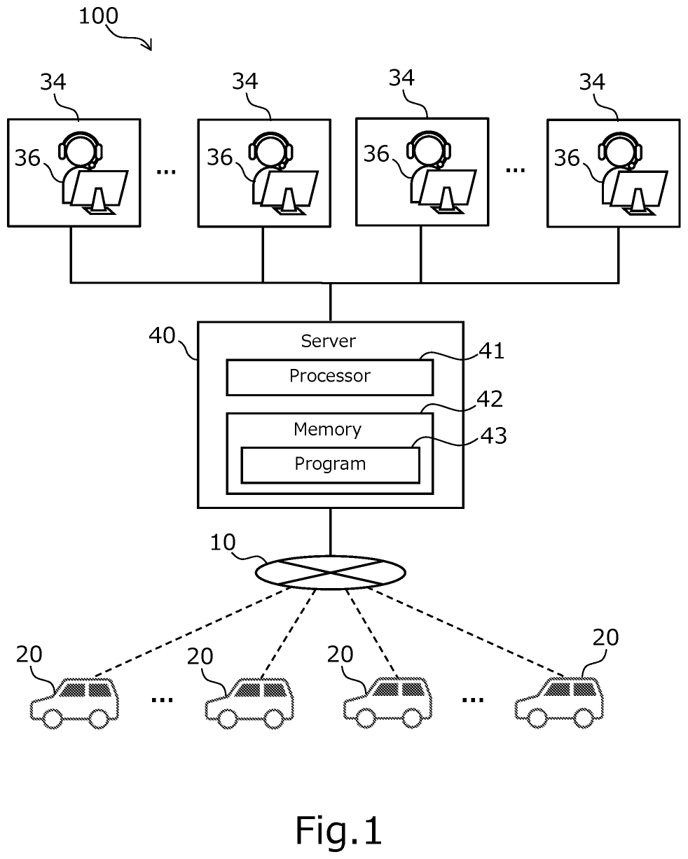

FIG. 1 is a configuration diagram of a remote monitoring system 100 for remotely monitoring autonomous vehicles 20. The remote monitoring system 100 is a system for remotely monitoring a plurality of autonomous vehicles 20 by a plurality of operators 36. However, not all of the autonomous vehicles 20 are constantly monitored by the operators 36. In the remote monitoring system 100, if there is a request for remote assistance from the autonomous vehicle 20 to be monitored, any one of the available operators 36 is assigned and the assigned operator 36 is caused to perform remote assistance. As the driving automation level of the autonomous vehicle 20 to be subject to remote monitoring in the remote monitoring system, for example, level 3 or more is assumed according to the definition of SAE (Society of Automotive Engineers). Hereinafter, the autonomous vehicle 20 is simply referred to as a vehicle 20.

In remote assistance by the remote monitoring system 100, at least a part of the determination for automatic driving by the vehicle 20 is performed by the operator 36. If there is no remote assistance by the operator 36, the determination of the autonomous traveling of the vehicle 20 must be conservative. Therefore, there is a concern that the traffic flow around the vehicle 20 may be affected by the vehicle 20 stopping or slowing down while traveling. However, in the remote monitoring system 100, remote assistance by the operator 36 can be obtained in case of the emergency, the vehicle 20 can perform an aggressive autonomous traveling such as traveling the shortest route to the destination.

When the vehicle 20 performs aggressive autonomous traveling, remote assistance by the operator 36 is expected to be required by the following factors, for example.

a. Misrecognition of traffic signal and non-detection of traffic signal (backlit, hidden by tracks, etc., signal without V2X)
b. Unstable recognition of preceding vehicle (the preceding vehicle is black or motorcycle with long distance form ego-vehicle, which is difficult to detect by LiDAR)
c. Crossing sidewalks with pedestrians and bicycles
d. Lane change on road with heavy on-road parking
e. Correction of stopping position (for responding to on-road parking, traffic jams, or obstacles)
f. Confirmation of surroundings when departing
g. Lane change for road construction and traffic control

In remote assistance, basic calculations regarding recognition, judgment, and operation necessary for driving are executed by the vehicle 20. The operator 36 determines what action the vehicle 20 should take based on the information transmitted from the vehicle 20 and gives instructions to the vehicle 20. The information transmitted from the vehicle 20 includes, for example, the image information of the periphery of the vehicle 20 captured by the vehicle-mounted camera, the voice information of the periphery of the vehicle 20 collected by the vehicle-mounted microphone, the target trajectory calculated by the vehicle 20 and the like. The instructions for remote assistance sent from the operator 36 to the vehicle 20 include an instruction to advance the vehicle 20 and an instruction to stop the vehicle 20. In addition, the instructions for remote assistance include an instruction to avoid an obstacle ahead, an instruction to overtake a preceding vehicle, and an instruction to evacuate emergently.

The remote monitoring system 100 includes a server 40. An operation terminal 34 operated by the operator 36 is connected to the server 40. Further, the vehicle 20 to be monitored by the remote monitoring system 100 is connected to the server 40 via a communication network 10 including a 4G or 5G. The server 40 may be located, for example, on a monitoring center or cloud.

The server 40 may be a computer or a collection of computers connected in a communication network. The server 40 includes at least one processor 41 (hereinafter, refer to as a processor 41) and at least one memory 42 (hereinafter, refer to as a memory 42) coupled to the processor 41. The memory 42 stores at least one program 43 (hereinafter, refer to as a program 43) execute by the processor 41 and various related information. The memory 42 includes a main storage device and an auxiliary storage device. The program 43 can be stored in the main storage device or in the auxiliary storage device. The auxiliary storage device stores a map database for managing map information for automatic driving.

When the processor 41 executes the program 43, various kinds of processing are executed by the processor 41. The program 43 includes a program to determine which operator 36 is assigned to the vehicle 20 requesting remote assistance upon request of remote assistance from the vehicle 20. After the operator 36 to be assigned is determined, the operation terminal 34 of the operator 36 and the vehicle 20 are connected to initiate communication for remote assistance.

Further, the program 43 includes a program (routing program) for causing the server 40 to function as a routing apparatus. The route to the destination of the vehicle 20 is provided from the server 40. The route to the destination is created based on the map information managed by the map database. There are multiple routes to destinations that the vehicle 20 may take. The function of the server 40 as a routing apparatus is a function of selecting a route from among a plurality of route candidates for each vehicle 20.

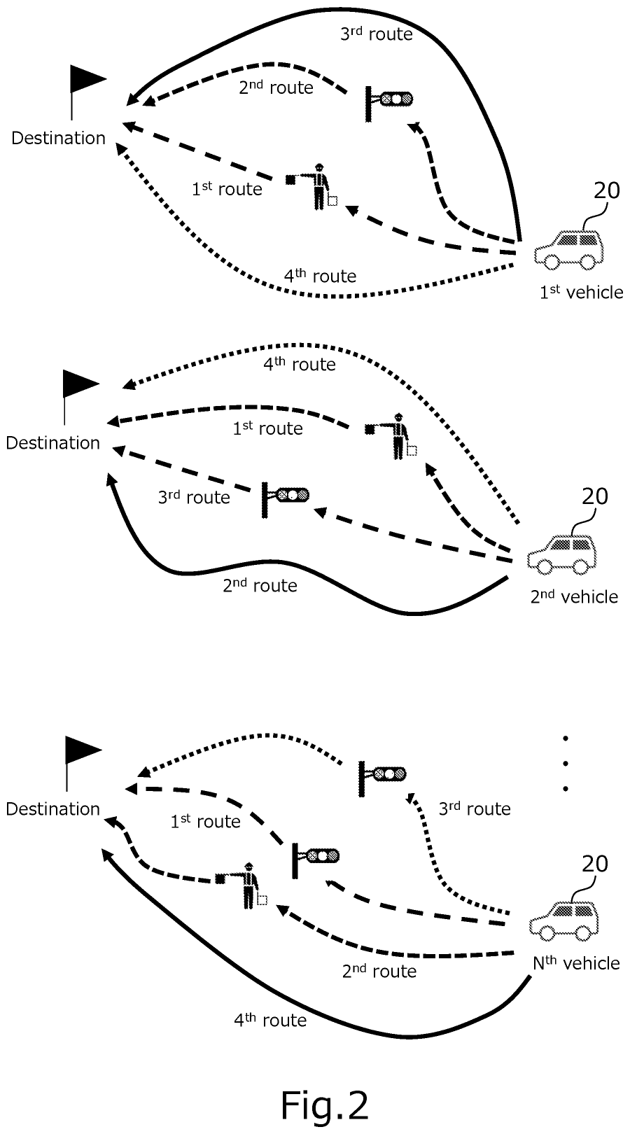

Here, an outline of the route selection by the server 40 as a routing apparatus will be described with reference to FIG. 2. Here, it is assumed that the N vehicles from the first vehicle to the Nth vehicle is monitored by the remote monitoring system 100. The server 40 generates a plurality of route candidates for each vehicle 20 and updates the route candidates according to the progress of the vehicle 20. That is, the server 40 generates a plurality of route candidates from the current location of the vehicle 20 to the destination at predetermined time intervals or at predetermined traveling distances. For example, the current route candidates for the first vehicle are four routes from the first route to the fourth route. However, one of them is the current route. Here, if the fourth route is selected, the first to third routes are erased, new route candidates are generated according to the position of the first vehicle after a predetermined time or after traveling a predetermined distance.

For each of the generated route candidates, the server 40 determines whether or not there are any of the factors listed above that are expected to require remote assistance. In the example shown in FIG. 2, among the route candidates of the first vehicle, the first route includes a road construction section, and the second route includes a signal without V2X. In the road construction section, it is expected that an assistance request will be generated for determination of the guidance of the guiding person and the surrounding situation. At the installation position of the traffic signal without V2X, it is expected that an assistance request will be generated for determination of the lighting color of the signal and the surrounding situation. Therefore, the first route and the second route among the route candidates of the first vehicle are determined to be routes in which the occurrence of remote assistance is predicted. Thus, in selecting a route from among a plurality of route candidates, the server 40 performs prediction of the occurrence of remote assistance for each route candidate of each vehicle. Incidentally, as the route where remote assistance is unlikely to occur, for example, a route with many straight lines, a route that does not pass through signals or intersections, and a route that does not require overtaking are exemplified.

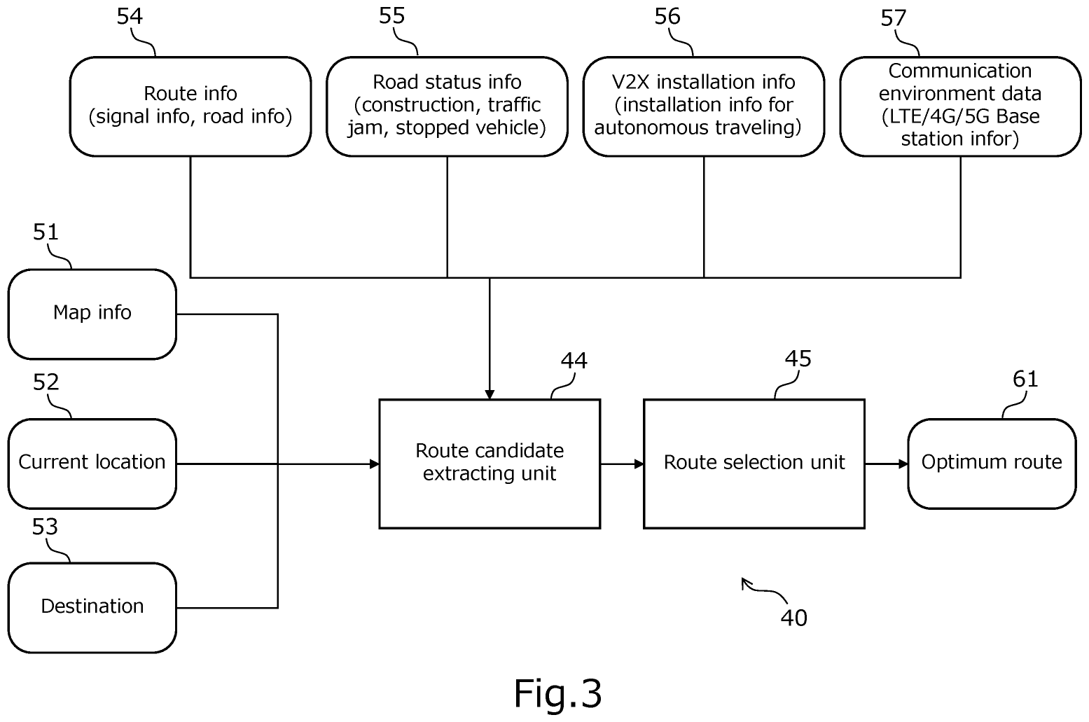

FIG. 3 is a block diagram illustrating an example of the configuration of the server 40 as a routing apparatus. The route candidate extracting unit 44 and the route selection unit 45 shown in FIG. 3 are functions of the server 40 as a routing apparatus implemented when the program 43 stored in the memory 42 and, in detail, the routing program are executed by the processor 41.

The route candidate extracting unit 44 obtains a plurality of types of information, for example, map information 51, current location 52 of each vehicle 20, destination 53 of each vehicle 20, route information 54, road status information 55, V2X installation information 56, and communication environment data 57. The route information 54 includes signal information and road information. The road status information 55 includes construction information, traffic jam information and on-road stop vehicle information. The V2X installation information 56 is infrastructure information for automatic driving. The communication environment data 57 includes LTE/4G/5G base station information.

The route candidate extracting unit 44 searches for route candidates for each vehicle 20 based on the obtained information 51 to 57. In the search of route candidates, an operation design domain (ODD) is referred to, and a route passing through an untravellable area is excluded from the route candidates. The route candidate extracting unit 44 predicts the occurrence of remote assistance for each searched route candidate. For a route in which the occurrence of remote assistance is predicted, the route candidate extracting unit 44 calculates a predicted occurrence time of remote assistance.

The route candidate extracting unit 44 calculates an assistance cost for each route candidate of each vehicle 20. The assistance cost for a certain route means a cost for remote assistance that is expected to occur in the certain route, and in particular a cost associated with a personnel expense of the operator 36 providing remote assistance. The assistance cost is expressed, for example, by the sum of predicted assistance times for each remote assistance. The more the number of remote assistances by the operator 36, the greater the assistance cost. The longer the assistance time per assistance, the greater the assistance cost.

Further, the route candidate extracting unit 44 calculates a vehicle cost for each route candidate of each vehicle 20. The vehicle cost of a certain route means an operation cost of the vehicle 20 in traveling on the certain route. The vehicle cost is expressed by, for example, a first-order polynomial with parameters such as a time required to arrive at the destination, fuel economy, and accident risk. The longer the time required to arrive at the destination, the greater the vehicle cost. The worse the fuel consumption, the greater the vehicle cost. The higher the accident risk, the greater the vehicle cost. In other words, selecting a route with a low vehicle cost can make the vehicle arrive quickly to the destination or improve fuel efficiency.

The route candidate extracting unit 44 extracts a predetermined number of combinations of route candidates from two different viewpoints among the combinations of route candidates between the vehicles 20. A first aspect in which the route candidate extracting unit 44 extracts combinations of route candidates is the assistance cost. In the first aspect, a predetermined number of combinations of route candidates are extracted in order of low assistance cost of the remote monitoring system 100 as a whole. A second aspect in which the route candidate extracting unit 44 extracts combinations of route candidates is the vehicle cost. In a second aspect, a predetermined number of combinations of route candidates are extracted in order of low vehicle cost of the remote monitoring system 100 as a whole.

The route candidate extracting unit 44 determines which combination of route candidates is to be extracted according to either of the two viewpoints by referring to the predicted value of an operator operating rate. The operator operating rate is defined by the number of working operators with respect to the total number of operators. The predicted value of the operator operating rate is the operator operating rate predicted when each vehicle 20 maintains the currently selected route. The route candidate extracting unit 44 predicts the occurrence of remote assistance for each vehicle 20 based on the route of each vehicle 20 currently selected and the operation status of each vehicle 20 and predicts the operator operating rate based on the prediction result of the occurrence of remote assistance for each vehicle 20.

The number of operators 36 who can provide remote assistance at the monitoring center is fixed. Therefore, in order to realize the smooth operation of the vehicles 20, the operator operating rate of the operators performing remote assistance is important. If the operator operating rate is excessively increased, it becomes difficult to respond to remote assistance, so that a delay occurs in the operation of the vehicle 20. On the other hand, if the operator operating rate is excessively lowered, it becomes impossible to select a route that requires remote assistance from the operator 36 but allows the vehicle 20 to arrive at the destination earlier.

In the remote monitoring system 100, the range of the operator operating rate with a margin is set as a target range so that the operator 36 can respond to an emergency. The emergency means the occurrence of an assistance request due to a factor related to the safety of the vehicle 20 or its surroundings, such as, for example, when the vehicle 20 encounters an accident or is likely to cause an accident. If the predicted value of the operator operating rate is higher than the target range, the operator operating rate can be reduced by selecting a combination of route candidates that reduce the assistance cost of the remote monitoring system 100 as a whole. On the other hand, if the predicted value of the operator operating rate is lower than the target range, a combination of route candidates that reduces the vehicle cost of the remote monitoring system 100 as a whole can be selected without worrying about the load of the operators 36.

The route selection unit 45 selects an optimal route 61 from the combinations of route candidates extracted by the route candidate extracting unit 44. The optimal route 61 is a combination of route candidates that can most smoothly operate the vehicles 20 under monitoring of the remote monitoring system 100 as a whole. The route selection unit 45 determines the optimal route 61 based on the difference between the predicted value of the operator operating rate and the target range thereof.

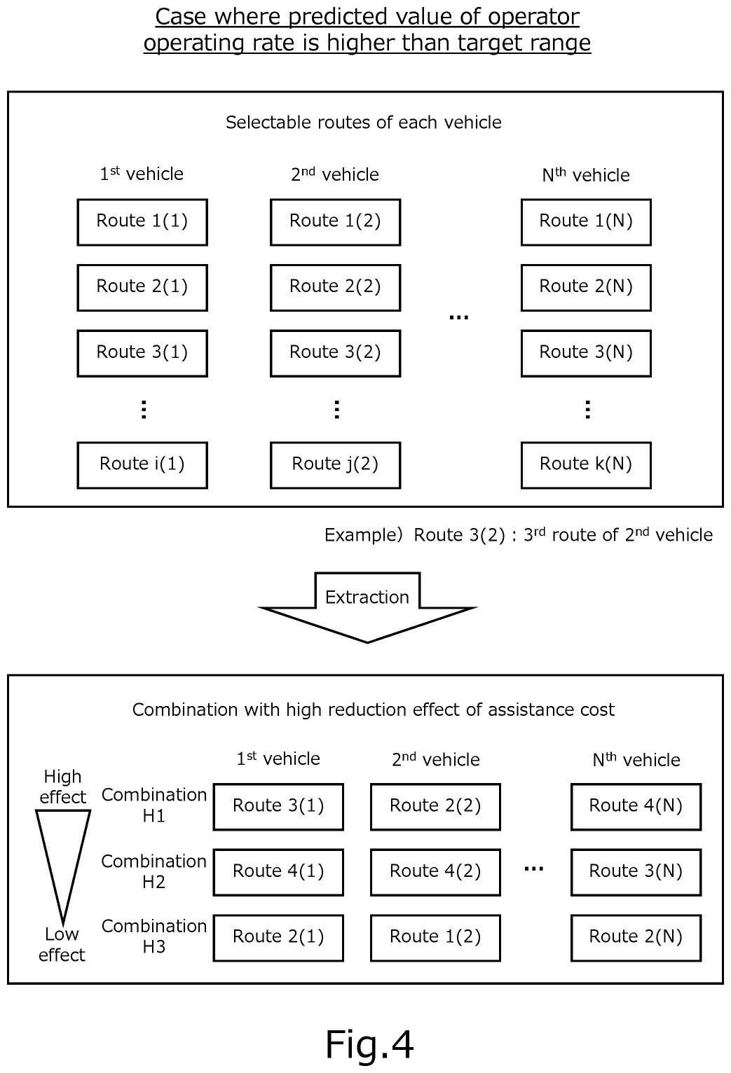

Hereinafter, the operation of the server 40 as a routing apparatus, that is, the route candidate extracting unit 44 and the route selection unit 45 will be described in detail with reference to FIGS. 4 to 7.

FIG. 4 is a diagram illustrating extraction of route candidates when the predicted value of the operator operating rate is higher than the target range. First, the route candidate extracting unit 44 searches for a route selectable for each vehicle. At this time, the ODD is referred to, and the route passing through the untravellable area is excluded from the selectable route.

If the predicted value of the operator operating rate is higher than the target range, the route candidate extracting unit 44 extracts a combination of routes that reduces the assistance cost of the operators 36 as a whole. Specifically, the route candidate extracting unit 44 first calculates the assistance cost individually for each route for each vehicle 20. The assistance cost calculated at this time is referred to as an individual assistance cost. The route candidate extracting unit 44 calculates the predicted assistance time for each remote assistance predicted in each route and calculates the sum of the predicted assistance times for each route. The sum of the predicted assistance times calculated for each route is used as the individual assistance cost for each route.

Next, the route candidate extracting unit 44 calculates the assistance cost due to the overlap of the occurrence timing of remote assistance between the vehicles 20. The assistance cost calculated at this time is referred to as an overlap assistance cost. By the combination of routes between the vehicles 20, the occurrence timings of remote assistance overlap or do not overlap among the plurality of vehicles 20. When the occurrence timings of remote assistance overlap, the number of operators 36 corresponding to the overlapping number is simultaneously required. The value obtained by converting the number of operators simultaneously performing remote assistance to a time cost is used as the overlap assistance cost.

A total assistance cost is calculated by adding the overlap assistance cost to the sum of the individual assistance costs for each vehicle 20. The route candidate extracting unit 44 extracts a predetermined number of combinations of route candidates in order of low total assistance cost, i.e., in order of high effect of reducing the assistance cost of the operators 36 as a whole. In the example shown in FIG. 4, the route combinations H1, H2, and H3 are extracted in order of low total assistance cost. In the example shown in FIG. 4, as the route combination H1, the third route is selected for the first vehicle, the second route is selected for the second vehicle, . . . , and, the fourth route is selected for the Nth vehicle. The total assistance cost of the route combination H1 in this case is calculated by “The total assistance cost=the individual assistance cost of the third route of the first vehicle+the individual assistance cost of the second route of the second vehicle+ . . . +the individual assistance cost of the fourth route of the Nth vehicle+the overlap assistance cost”.

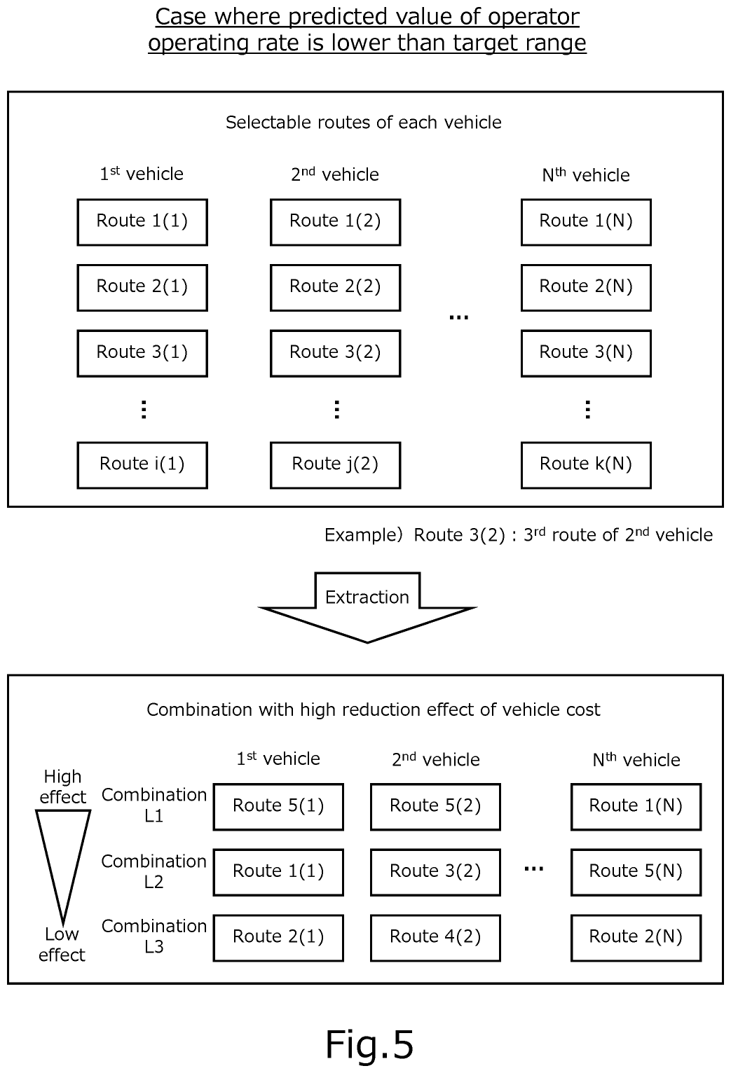

FIG. 5 is a diagram illustrating extraction of route candidates when the predicted value of the operator operating rate is lower than the target range. First, the route candidate extracting unit 44 searches for a selectable route for each vehicle. At this time, the ODD is referred to, and the route passing through the untravellable area is excluded from the selectable route.

If the predicted value of the operator operating rate is lower than the target range, the route candidate extracting unit 44 extracts a combination of routes that reduces the vehicle cost of the vehicles 20 as a whole. Specifically, the route candidate extracting unit 44 first calculates the vehicle cost individually for each route for each vehicle 20. The vehicle cost calculated at this time is referred to as an individual vehicle cost.

The total vehicle cost is calculated by summing the individual vehicle costs per vehicle 20. The route candidate extracting unit 44 extracts a predetermined number of combinations of route candidates in order of low total vehicle cost, i.e., in order of high effect of reducing the vehicle cost. In the example shown in FIG. 5, the route combinations L1, L2, and L3 are extracted in order of low total vehicle cost. In the example shown in FIG. 5, as the route combination L1, the fifth route is selected for the first vehicle, the fifth route is selected for the second vehicle, . . . , and, the first route is selected for the Nth vehicle. The total vehicle cost of the route combination L1 in this case is calculated by “The total vehicle cost=the individual vehicle cost of the fifth route of the first vehicle+the individual vehicle cost of the fifth route of the second vehicle+ . . . +the vehicle cost of the first route of the Nth vehicle”.

As described above, the route candidate extracting unit 44 extracts the route combination H1, H2, and H3 when the predicted value of the operator operating rate is higher than the target range, and extracts the route combination L1, L2, and L3 when the predicted value of the operator operating rate is lower than the target range. The route selection unit 45 selects a combination according to the predicted value of the operator operating rate from among the combinations of the routes extracted by the route candidate extracting unit 44.

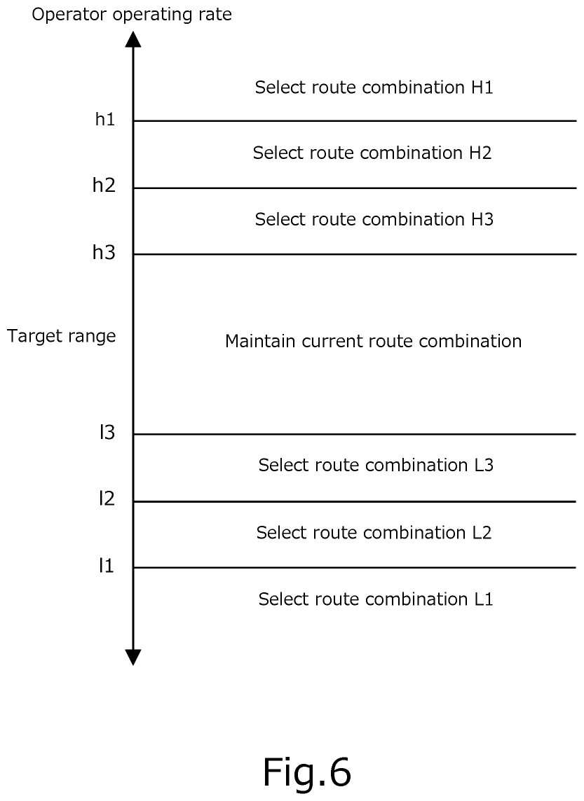

FIG. 6 is a diagram showing selection of a combination of routes according to the predicted value of the operator operating rate by the route selection unit 45. In the example shown in FIG. 6, the target range of the operator operating rate is a range from the upper limit h3 to the lower limit l3. When the predicted value of the operator operating rate is within the target range, the route selection unit 45 maintains the current route combination.

A threshold h2 higher than the upper limit h3 of the target range and a threshold h1 higher than the threshold h2 are set for the operator operating ratio. When the predicted value of the operator operating rate is higher than the threshold h1, the route combination H1 with the highest reduction effect of the assistance cost is selected. When the predicted value of the operator operating rate is equal to or lower than the threshold h1 and higher than the threshold h2, the route combination H2 with the second highest reduction effect of the assistance cost is selected. Then, when the predicted value of the operator operating rate is equal to or lower than the threshold h2 and higher than the upper limit h3, the route combination H3 with the third highest reduction effect of the assistance cost is selected. Thus, by changing the combination of routes according to the difference between the predicted value of the operator operating rate and the upper limit h3 of the target range, it is possible to prevent the operator operating rate from being decreased more than expected.

Further, a threshold 12 lower than the lower limit l3 of the target range and a threshold 11 lower than the threshold 12 are set for the operator operating rate. When the predicted value of the operator operating rate is lower than the threshold 11, the route combination L1 with the highest reduction effect of the vehicle cost is selected. When the predicted value of the operator operating rate is equal to or higher than the threshold 11 and lower than the threshold 12, the route combination L2 with the second highest reduction effect of the vehicle cost is selected. Then, when the predicted value of the operator operating rate is equal to or higher than the threshold 12 and lower than the lower limit l3, the route combination L3 with the third highest reduction effect of the vehicle cost is selected. Thus, by changing the combination of routes according to the difference between the predicted value of the operator operating rate and the lower limit l3 of the target range, it is possible to prevent the operator operating rate from being increased more than expected.

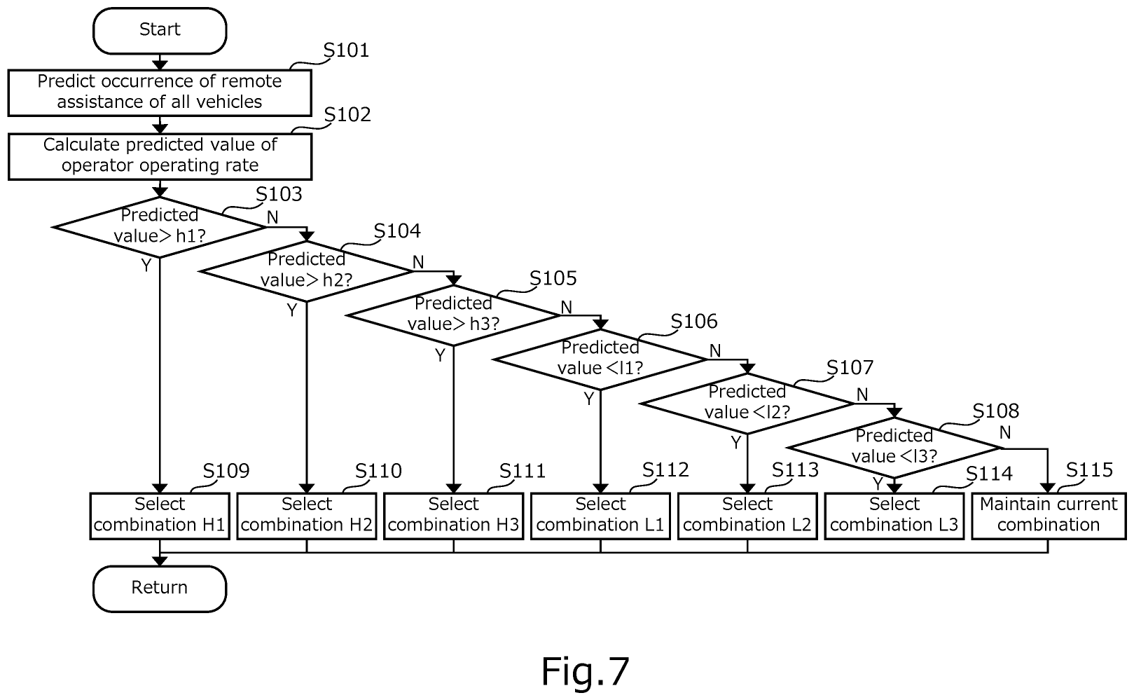

FIG. 7 is a flowchart illustrating a procedure for selecting a combination of routes by the server 40 as a routing apparatus. This flowchart illustrates a routing method according to the embodiment of the present disclosure. In the step S101 of the flowchart, it is predicted whether or not the occurrence of remote assistance when the current routes are maintained for all vehicles 20. In the step S102, the predicted value of the operator operating rate is calculated based on the predicted results at the step S101.

Following the step S102, the step S103 is executed. In the step S103, the predicted value of the operator operating rate is compared with the threshold h1. If the predicted value is higher than the threshold h1, the route combination H1 is selected at the step S109.

If the predicted value is lower than or equal to the threshold h1, the step S104 is executed. In the step S104, the predicted value of the operator operating rate is compared with the threshold h2. If the predicted value is higher than the threshold h2, the route combination H2 is selected at the step S110.

If the predicted value is lower than or equal to the threshold h2, the step S105 is executed. In the step S105, the predicted value of the operator operating rate is compared with the upper limit h3 of the target range. If the predicted value is higher than the upper limit h3 of the target range, the route combination H3 is selected at the step S111.

If the predicted value is lower than or equal to the upper limit h3 of the target range, the step S106 is executed. In the step S106, the predicted value of the operator operating rate is compared with the threshold 11. If the predicted value is lower than the threshold 11, the route combination L1 is selected at the step S112.

If the predicted value is higher than or equal to the threshold 11, the step S107 is executed. In the step S107, the predicted value of the operator operating rate is compared with the threshold 12. If the predicted value is lower than the threshold 12, the route combination L2 is selected at the step S113.

If the predicted value is higher than or equal to the threshold 12, the step S108 is executed. In the step S108, the predicted value of the operator operating rate is compared with the lower limit l3 of the target range. If the predicted value is lower than the lower limit l3 of the target range, the route combination L3 is selected at the step S114.

If the predicted value is higher than or equal to the lower limit l3 of the target range, the step S115 is executed. In the step S115, the current route combination is maintained.

As is apparent from the above description, according to the present embodiment, when the predicted value of the operator operating rate is higher than the target range, the operator operating rate can be automatically lowered to the target range by selecting routes to reduce the assistance cost. On the other hand, when the predicted value of the operator operating rate is lower than the target range, since operators can afford to perform remote assistance sufficiently, it is possible to operate the operation of the vehicles 20 smoothly by selecting routes to reduce the vehicle cost. That is, according to the present embodiment, by selecting routes in consideration of the vehicle cost and the assistance cost so as to keep the operator operating rate within the target range, it is possible to suppress the personnel expenses of the operators 36 while maintaining the smooth operation of the vehicles 20.

Incidentally, as a modification of the present embodiment, if the predicted value of the operator operating rate is higher than the target range, the route combination H1 with the highest reduction effect of the assistance cost may be selected, and if the predicted value of the operator operating rate is lower than the target range, the route combination L1 with the highest reduction effect of the vehicle cost may be selected.

What is claimed is:

1. A routing apparatus applied to a system configured to cause a plurality of operators to remotely monitor a plurality of vehicles capable of autonomous traveling and cause any one of the plurality of operators to perform remote assistance in response to an assistance request from any one of the plurality of vehicles, the routing apparatus comprising:
at least one memory storing at least one program, and
at least one processor coupled to the at least one memory,
wherein the at least one program is configured to cause the at least one processor to execute:
predicting occurrence of remote assistance for each of the plurality of vehicles based on a currently selected route of each of the plurality of vehicles and an operation status of each of the plurality of vehicles;
predicting an operating rate of the plurality of operators as a whole based on a prediction result of the occurrence of remote assistance for each of the plurality of vehicles;
in response to the operating rate being higher than a target range, changing a combination of routes of the plurality of vehicles to a combination to reduce an assistance cost of the plurality of operators as a whole as compared with a currently selected combination; and
in response to the operating rate being lower than the target range, changing the combination of routes of the plurality of vehicles to a combination to reduce a vehicle cost of the plurality of vehicles as a whole as compared with the currently selected combination.

2. The routing apparatus according to claim 1, wherein the at least one program is configured to cause the at least one processor to execute, in response to the operating rate being higher than the target range:
extracting a predetermined number of combinations of routes of the plurality of vehicles in order of high reduction effect of the assistance cost; and
selecting the combination to reduce the assistance cost among the predetermined number of combinations.

3. The routing apparatus according to claim 2, wherein the at least one program is configured to cause the at least one processor to execute selecting a combination having higher reduction effect of the assistance cost as the operating rate is higher than the target range.

4. The routing apparatus according to claim 1, wherein the at least one program is configured to cause the at least one processor to execute, in response to the operating rate being lower than the target range:
extracting a predetermined number of combinations of routes of the plurality of vehicles in order of high reduction effect of the vehicle cost; and
selecting the combination to reduce the vehicle cost among the predetermined number of combinations.

5. The routing apparatus according to claim 4, wherein the at least one program is configured to cause the at least one processor to execute selecting a combination having higher reduction effect of the vehicle cost as the operating rate is lower than the target range.

6. A routing method applied to a system configured to cause a plurality of operators to remotely monitor a plurality of vehicles capable of autonomous traveling and cause any one of the plurality of operators to perform remote assistance in response to an assistance request from any one of the plurality of vehicles, the routing method comprising:
predicting occurrence of remote assistance for each of the plurality of vehicles based on a currently selected route of each of the plurality of vehicles and an operation status of each of the plurality of vehicles;
predicting an operating rate of the plurality of operators as a whole based on a prediction result of the occurrence of remote assistance for each of the plurality of vehicles;
in response to the operating rate being higher than a target range, changing a combination of routes of the plurality of vehicles to a combination to reduce an assistance cost of the plurality of operators as a whole as compared with a currently selected combination; and
in response to the operating rate being lower than the target range, changing the combination of routes of the plurality of vehicles to a combination to reduce a vehicle cost of the plurality of vehicles as a whole as compared with the currently selected combination.

7. A non-transitory computer-readable storage medium storing a routing program applied to a system configured to cause a plurality of operators to remotely monitor a plurality of vehicles capable of autonomous traveling and cause any one of the plurality of operators to perform remote assistance in response to an assistance request from any one of the plurality of vehicles, the routing program being configured to cause a computer to execute:
predicting occurrence of remote assistance for each of the plurality of vehicles based on a currently selected route of each of the plurality of vehicles and an operation status of each of the plurality of vehicles;
predicting an operating rate of the plurality of operators as a whole based on a prediction result of the occurrence of remote assistance for each of the plurality of vehicles;
in response to the operating rate being higher than a target range, changing a combination of routes of the plurality of vehicles to a combination to reduce an assistance cost of the plurality of operators as a whole as compared with a currently selected combination; and
in response to the operating rate being lower than the target range, changing the combination of routes of the plurality of vehicles to a combination to reduce a vehicle cost of the plurality of vehicles as a whole as compared with the currently selected combination.
